(19) United States
(12) Patent Application Publication
(10) Pub. No.: US 2021/0149048 A1
(43) Pub. Date: May 20, 2021

(54) DISTANCE MEASURING DEVICE

(71) Applicant: Hitachi-LG Data Storage, Inc., Tokyo (JP)

(72) Inventor: Kozo MASUDA, Tokyo (JP)

(21) Appl. No.: 17/071,138

(22) Filed: Oct. 15, 2020

(30) Foreign Application Priority Data
Nov. 14, 2019 (JP) 2019-206440

(51) Int. Cl. G01S 17/10; G01S 7/4865; G01S 17/894; G06T 7/80

(52) U.S. Cl. CPC G01S 17/10; G01S 7/4865; G06T 2207/10028; G06T 7/80; G01S 17/894

(57) ABSTRACT

A distance measuring device 1 includes a light emitting unit 11 that irradiates a subject with irradiation light, a light receiving unit 12 that receives reflected light from the subject, a distance calculating unit 14 that calculates a distance to the subject from an output signal of the light receiving unit, and an image processing unit 15 that generates a distance image of the subject from the calculated distance. The image processing unit 15 executes image processing within a period when the light emitting unit 11 stops the light emission and stops the image processing during a period when the light emitting unit 11 emits the light. When the image processing unit 15 stops the image processing, a clock frequency of an integrated circuit constituting the image processing unit 15 is further reduced as compared with an image processing time.

### CLAIM OF PRIORITY

The present application claims priority from Japanese patent application serial No. JP 2019-206440, filed on Nov. 14, 2019, the content of which is hereby incorporated by reference into this application.

### BACKGROUND OF THE INVENTION

### (1) Field of the Invention

The present invention relates to a distance measuring device that measures a distance to a subject by a time of flight of light.

### (2) Description of the Related Art

A distance-measuring imaging device (hereinafter, a distance measuring device) using a method (TOF=Time Of Flight) of measuring the distance by a time of flight until the irradiation light is reflected by the subject and returns in order to measure the distance to the subject and obtain a distance image has been put into practical use. For the distance measurement, the distance measuring device periodically repeats the emission of the irradiation light and the exposure to the reflected light and calculates a time delay of the reflected light with respect to the irradiation light from the exposure amount accumulated during a predetermined exposure period to obtain the distance. After that, image processing for colorizing the distance value to the subject on the basis of a distance data is performed and output as a two-dimensional distance image.

As a condition of the environment in which the distance measuring device is used, a standard of a power supply is defined. Therefore, in order to execute predetermined performance with a predetermined peak power or less, power reduction of the device is required. As a technique related to the power reduction technique, for example, JP 2007-121755 A discloses a configuration of reducing the peak power in a light emitting device of a camera. This device is configured to suppress an increase in peak power of a power supply (battery) by supplying electric power to a light emitting unit from a large-capacity capacitor charged with electric charges.

### SUMMARY OF THE INVENTION

The peak power according to the standard is defined for the power supply that supplies electric power to the distance measuring device. Therefore, in order to reduce the system cost, new power reduction is required so as to operate at the peak power or less. In the power reduction technique disclosed in JP 2007-121755 A, it is required to secure a mounting space in order to add a large-capacity capacitor, and thus, the cost of the device is increased.

In addition, as a general power reduction technique, it is considered that the peak power is reduced by shifting the operation period of a plurality of components (circuits) in the device. However, in the distance measuring device using the TOF method, it is required to reduce the power consumption while maintaining the total performance including not only a light emission operation and an exposure operation but also the start and completion timings of the distance calculating and the image processing. Such a requirement has not been taken into consideration in the related art.

In view of the above-described problems, the present invention is to provide a distance measuring device that reduces a peak value of current consumption without adding a new component.

According to an aspect of the present invention, there is provided a distance measuring device having a configuration of including: a light emitting unit irradiating a subject with pulsed light emitted from a light source; a light receiving unit exposing an image sensor to pulsed light reflected by the subject and converting the pulsed light into an electrical signal; a distance calculating unit calculating a distance to the subject from an output signal of the light receiving unit; and an image processing unit generating a distance image of the subject from the distance calculated by the distance calculating unit, in which the image processing unit executes image processing within a period when the light emitting unit stops light emission and stops the image processing during a period when the light emitting unit emits light.

In addition, according to another aspect of the present invention, there is provided a distance measuring device having a configuration of further including an operation mode control unit switching operation modes of the distance calculating unit and the image processing unit, in which, during a period when the light emitting unit performs light emission, the operation mode control unit sets the distance calculating unit to a low power mode in which calculation processing is stopped and sets the image processing unit to the low power mode in which image processing is stopped, and in which, within the period when the light emitting unit stops the light emission, the operation mode control unit sets a period of a normal mode in which the distance calculating unit executes the calculation process and a period of the normal mode in which the image processing unit executes the image processing not to overlap with each other.

According to the present invention, it is possible to realize a distance measuring device that easily reduces a peak value of current consumption without adding a new component.

### BRIEF DESCRIPTION OF THE DRAWINGS

These and other features, objects and advantages of the present invention will become more apparent from the following description when taken in conjunction with the accompanying drawings wherein:

FIG. 1 is a diagram illustrating a configuration of a distance measuring device 1 according to a first embodiment;

FIG. 2A is a diagram describing operations of a distance measuring unit (TOF camera) 10;

FIG. 2B is a diagram describing an example of a calculation method at a distance measurement time;

FIG. 3 is a diagram illustrating an example of a distance image;

FIG. 4 is a time chart illustrating operations of each unit of a distance measuring device in the related art;

FIG. 5 is a time chart illustrating operations of each unit of the distance measuring device according to the first embodiment;

FIG. 6 is a flowchart for executing operation switching of FIG. 5;

FIG. 7 is a diagram illustrating a configuration of a distance measuring device 1′ according to a second embodiment;

FIG. 8 is a time chart illustrating operations of each unit of the distance measuring device according to the second embodiment;

FIG. 9 is a diagram illustrating comparison of magnitudes of current consumption of respective units in FIG. 8;

FIG. 10 is a flowchart for executing operation switching of FIG. 8;

FIG. 11 is a diagram illustrating a configuration of a distance measuring device 1″ according to a third embodiment; and

FIG. 12 is a time chart illustrating operations of each unit of the distance measuring device according to the third embodiment.

### DETAILED DESCRIPTION OF THE EMBODIMENT

Hereinafter, embodiments of a distance measuring device according to the present invention will be described. In order to suppress a peak value of a current consumption, a configuration of controlling a time of image processing will be described in a first embodiment, and a configuration of controlling timings of image processing and distance calculating will be described in a second embodiment. In addition, a configuration including two systems of light emitting unit and light receiving units will be described in a third embodiment.

### First Embodiment

FIG. 1 is a diagram illustrating a configuration of a distance measuring device according to a first embodiment. The distance measuring device 1 measures a distance to a subject such as a person or an object by a TOF method, displays the measured distance to each unit of the subject in, for example, color, and outputs the measured distance as a distance image.

The distance measuring device 1 includes a distance measuring unit 10 (hereinafter, TOF camera) that acquires a distance data according to the TOF method and an image processing unit 15 that extracts a portion of a subject such as a person from the distance data to generate a distance image. A power supply unit 16 supplies electric power to the TOF camera 10 and the image processing unit 15 in the distance measuring device 1.

The TOF camera 10 includes a light emitting unit 11 that irradiates a subject with pulsed light, a light receiving unit 12 that receives the pulsed light reflected from the subject, a light emission control unit 13 that controls a light emission operation of the light emitting unit 11, and a distance calculating unit 14 that calculates the distance from a detection signal (light reception data) of the light receiving unit 12 to the subject.

The image processing unit 15 is configured with, for example, a CPU (microprocessor), performs colorization processing for changing the color of a subject image on the basis of the distance data from the distance calculating unit 14, and outputs the subject image to an external device or displays the subject image on a display or the like. The image processing may be processing for changing brightness, contrast, or the like. A user can easily know the position (distance) and shape (posture) of a subject such as a person by looking at the colorized distance image.

The light receiving unit 12 outputs an exposure signal (illustrated by a broken line) indicating an exposure/non-exposure operation. The light emission control unit 13 controls the light emission period/extinguishment period of the light emitting unit 11 on the basis of the exposure signal. The distance calculating unit 14 calculates the distance from the light reception data on the basis of the exposure signal. Furthermore, in the present embodiment, the image processing unit 15 is characterized to have a configuration of switching an operation mode between a “normal mode” for executing the image processing and a “low power mode” for stopping the image processing on the basis of the exposure signal.

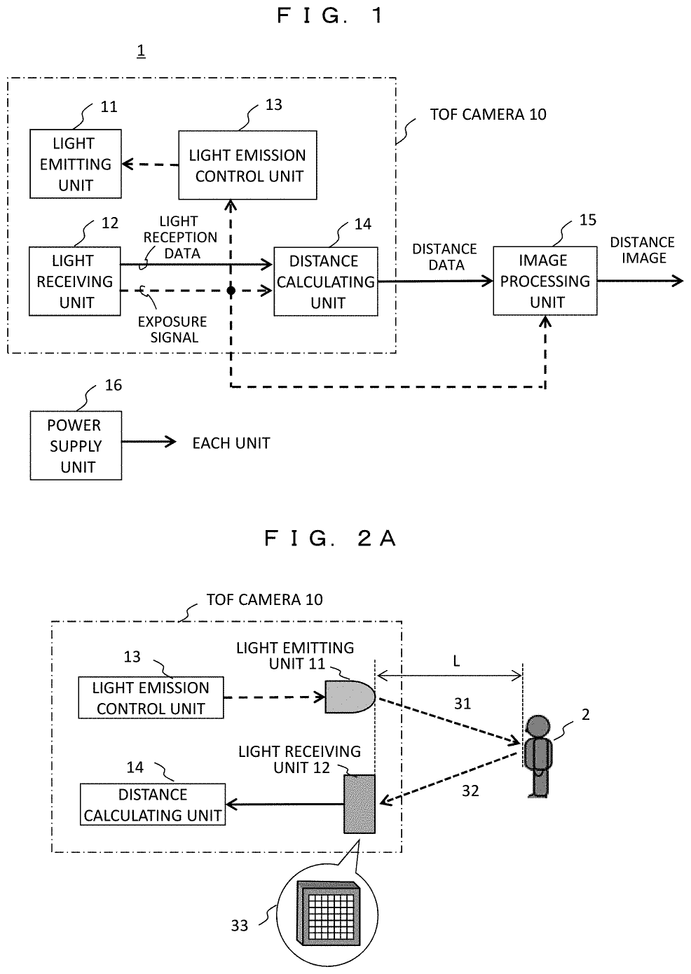

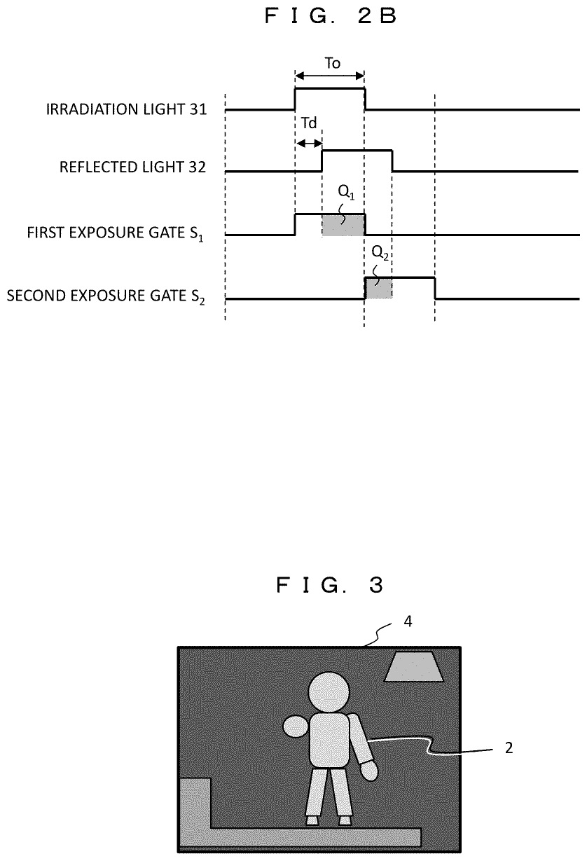

FIG. 2A is a diagram describing operations of the distance measuring unit (TOF camera) 10. The light emitting unit 11 emits pulsed irradiation light 31 such as a laser from a light source such as a laser diode (LD) toward a subject 2. The light receiving unit 12 detects pulse-shaped reflected light 32 that is returned light of the irradiation light 31 reflected by the subject 2. The light receiving unit 12 exposes an image sensor in which CCD sensors and the like are arranged two-dimensionally to the reflected light 32 to convert the exposure amount at each pixel position into an electric signal (charge amount). The distance calculating unit 14 calculates a distance L from the light reception data (charge amount) in the light receiving unit 12 to the subject 2 to generate a two-dimensional distance data.

FIG. 2B is a diagram describing an example of a calculation method at a distance measurement time. In the distance measurement, the distance L to the subject 2 can be obtained by L=Td×c/2 on the basis of a time difference Td between the irradiation light 31 and the reflected light 32 (where c is the speed of light). Herein, a case is illustrated in which the exposure operation is divided into, for example, two gates for one irradiation light 31 (pulse width T₀). That is, the exposure operation of the reflected light 32 is divided into a first exposure gate S₁ and a second exposure gate S₂ subsequent to the first exposure gate, and the respective gate widths are allowed to be equal to the pulse width T₀ of the irradiation light 31. The time difference Td can be obtained from the charge amounts Q₁ and Q₂ accumulated in the first and second exposure gates S₁ and S₂ among the charge amounts Q accumulated in the image sensor 33 and the pulse width T₀ of the irradiation light as follows.

Td=T₀×Q₂/(Q₁+Q₂)

From this, the distance L is calculated as follows.

L=T₀×Q₂/(Q₁+Q₂)×c/2

In addition, herein, the charge amount of background light is ignored for the simplicity.

In an actual distance measurement, irradiation with pulsed light as irradiation light 31 is repeatedly performed at predetermined intervals, and exposure to the reflected light is repeatedly performed at exposure gates at predetermined intervals to improve measurement accuracy.

The distance calculating unit 14 performs the above-described calculation by using a programmable logic device such as a field programmable gate array (FPGA).

FIG. 3 is a diagram illustrating an example of the distance image. The image processing unit 15 generates a two-dimensional distance image 4 on the basis of the two-dimensional distance data output from the distance calculating unit 14. In the image processing, the distance data to each unit of the subject is colorized according to the distance value and output as an image of two-dimensional color data. As a result, for example, a short distance portion is displayed in “red”, and a long distance portion is displayed in “blue”. The user can know the shape (contour or unevenness) of the subject 2 and the distance to the subject 2. In addition, in FIG. 3 attached, the distance value is represented by gray scale (brightness) instead of color.

In addition to the above-described processing, the image processing unit 15 can display the subject more clearly by performing noise removal processing for removing shot noise included in the received light signal, difference processing for removing an object serving as a background from the distance image, and the like. The processing is performed by a CPU (microprocessor).

Hereinafter, the operations of the distance measuring device according to the embodiment will be described in detail, but for comparison, the operations of a general distance measuring device in the related art will be described.

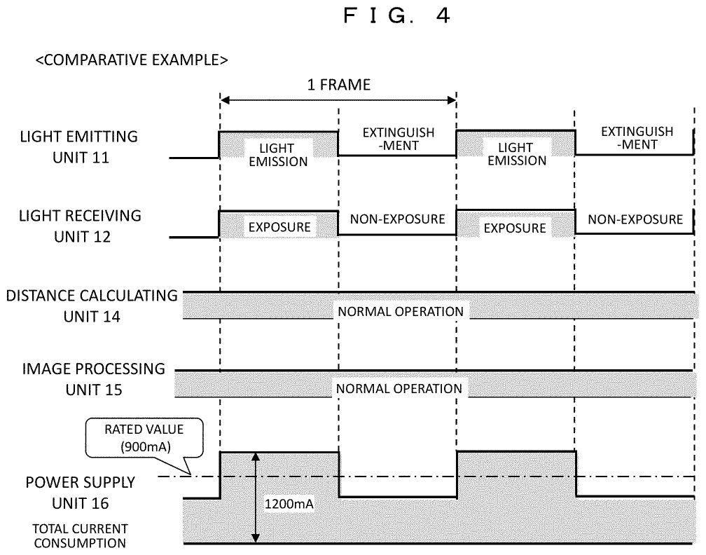

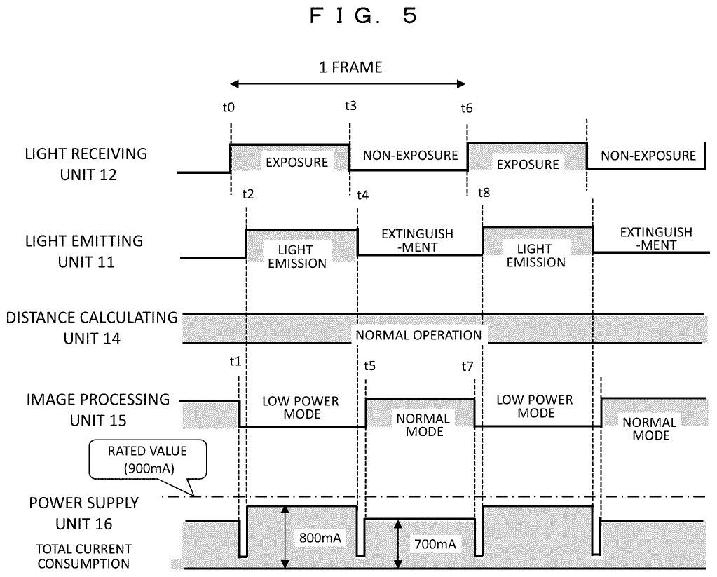

FIG. 4 is a time chart illustrating operations of each unit of the distance measuring device in the related art. With one frame as a cycle, the light emitting unit 11 alternately repeats the light emission period and the extinguishment period, and the light receiving unit 12 alternately repeats the exposure period and the non-exposure period. In addition, in one light emission period and one exposure period, the light emission pulse illustrated in FIG. 2B and the exposure gate subsequent to the light emission pulse are repeatedly executed a plurality of times. The light emission period and the exposure period are substantially coincident in time, and the extinguishment period and the non-exposure period are substantially coincident in time. On the other hand, the distance calculating unit 14 and the image processing unit 15 continuously perform the distance calculating operation and the image processing operation while the distance measuring device 1 is operating (normal operation state).

The light emitting unit 11 consumes power for the light emission operation of the light source during the light emission period. A clock signal for performing a normal operation is supplied to the integrated circuit constituting the distance calculating unit 14 and the image processing unit 15, and each circuit consumes power for the processing operation. For this reason, the total current consumption supplied from the power supply unit 16 becomes maximum during the light emission period (exposure period), and for example, the peak value becomes 1200 mA and exceeds the rated value (target value) of 900 mA of the power supply unit 16.

In contrast, the first embodiment has a configuration of reducing the total current consumption by providing the “low power mode” of stopping the image processing as the operation mode of the image processing unit 15 during the light emission period.

FIG. 5 is a time chart illustrating operations of each unit of the distance measuring device according to the first embodiment. The distance measurement is performed in unit of frames and is measured at a rate of, for example, 30 frames/sec. In the time chart, the operation of the light receiving unit 12 is illustrated in the uppermost stage, but as described below, this is because the operation timing of each unit is determined on the basis of the timing of the exposure signal of the light receiving unit 12.

The difference from the operation in the related art illustrated in FIG. 4 is that, as the operation mode of the image processing unit 15, a “low power mode” of stopping the image processing is provided in addition to the “normal mode” of performing the normal image processing. Then, the image processing unit 15 is set to the “normal mode” during the non-exposure period of the light receiving unit 12 (extinguishment period of the light emitting unit 11), but the image processing unit 15 is set to the “low power mode” during the exposure period of the light receiving unit 12 (light emission period of the light emitting unit 11). Switching of the operation mode is performed by switching the clock frequency of the CPU constituting the image processing unit 15, and according to the standard of the CPU to be used, the clock frequency is set to, for example, f=1 GHz in the “normal mode” and f=several hundred kHz in the low power mode. By reducing the clock frequency, the image processing unit 15 shifts to the standby mode, and the power consumption is significantly reduced.

In addition, the switching timings (t0, t1, . . . ) of operations of the respective units are set as follows.

[1] Starting of exposure of the light receiving unit 12 (t0)->Switching of the image processing unit 15 to the “low power mode” (t1)->Starting of light emission of the light emitting unit 11 (t2)

[2] Completion of exposure of the light receiving unit 12 (t3)->Stopping of light emission of the light emitting unit (t4)->Switching of the image processing unit 15 to the “normal mode” (t5)

By performing these operations in this order, a slight delay time (several msec) is provided for operation switching of each unit.

By setting the operation mode as described above, the light emission period (t2 to t4) of the light emitting unit 11 and the normal mode period (t5 to t7) of the image processing unit 15 do not overlap with each other. As a result, for example, a peak value during the light emission period (t2 to t4) is reduced to of 800 mA, and thus, the total current consumption of the power supply unit 16 can be suppressed to be less than the rated value of 900 mA. In addition, since the delay time is provided for the operation switching of each unit, the current consumption does not momentarily exceed the rated value due to the overlapping of the operations of the respective units at the operation switching time.

According to the above-described operation mode, as compared with the example in the related art of FIG. 4, the period when the image processing unit 15 is capable of performing the image processing is shortened to the normal mode period (t5 to t7). Therefore, the length of the non-exposure period (t3 to t6) is set so that the image processing of the distance data obtained during the immediately previous exposure period (t0 to t3) is completed in this period.

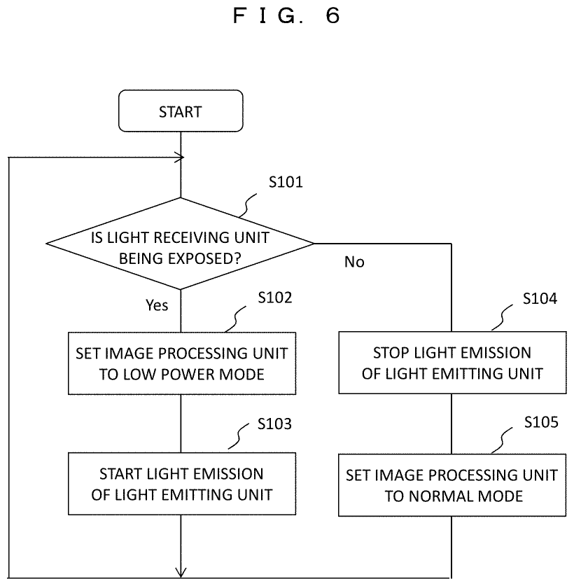

FIG. 6 is a flowchart for executing the operation switching of FIG. 5.

S101: it is determined on the basis of the exposure signal from the light receiving unit 12 whether or not the light receiving unit 12 is being currently exposed. If it is being exposed (Yes), the process proceeds to S102, and if it is not being exposed (No), the process proceeds to S104.

S102: The image processing unit 15 sets the operation mode to the low power mode (timing t1). Specifically, the clock frequency of the CPU is switched to, for example, several 100 kHz.

S103: The light emission control unit 13 allows the light emitting unit 11 to start the light emission (timing t2). After that, the process returns to S101.

S104: The light emission control unit 13 allows the light emitting unit 11 to stop light emission (timing t4).

S105: The image processing unit 15 sets the operation mode to the normal mode (timing t5). Specifically, the clock frequency of the CPU is switched to, for example, 1 GHz. After that, the process returns to S101.

According to the first embodiment, the light emission period of the light emitting unit 11 does not overlap with the image processing period of the image processing unit 15. As a result, the total current consumption of the power supply unit 16 can be suppressed to be less than the rated value without adding a new component such as a large-capacity capacitor as described in JP 2007-121755 A. In addition, by appropriately setting the length of the non-exposure period (t3 to t6), the image processing performance does not deteriorate.

### Second Embodiment

A second embodiment has a configuration of providing a “low power mode” for stopping the distance calculating as an operation mode of the distance calculating unit 14 in order to further reduce the total current consumption of the power supply unit 16.

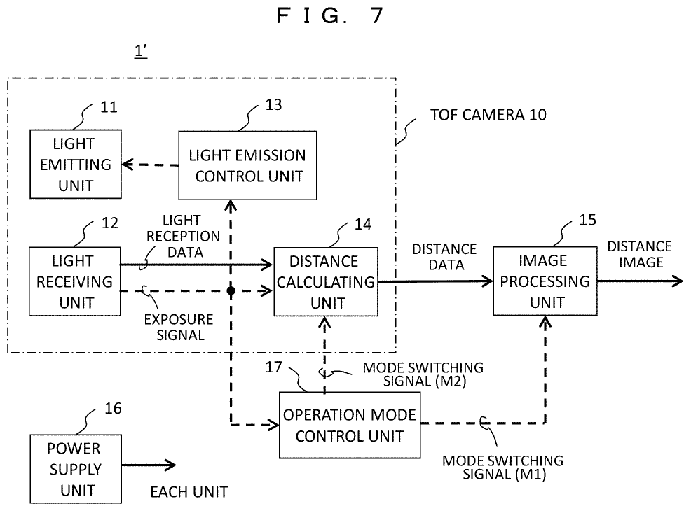

FIG. 7 is a diagram illustrating a configuration of the distance measuring device 1′ according to the second embodiment. The difference from the distance measuring device 1 of the first embodiment (FIG. 1) is that an operation mode control unit 17 that switches the operation modes of the distance calculating unit 14 and the image processing unit 15 is provided. The operation mode control unit 17 transmits a mode switching signal (M1) to the image processing unit 15 on the basis of an exposure signal indicating exposure/non-exposure operation from the light receiving unit 12, and also transmits a mode switching signal (M2) to the distance calculating unit 14. As a result, the operation mode of the image processing unit 15 is switched between the “normal mode” in which the image processing is executed and the “low power mode” in which the image processing is stopped. In addition, the operation mode of the distance calculating unit 14 is switched between the “normal mode” in which the distance calculating is executed and the “low power mode” in which the distance calculating is stopped. The power supply unit 16 supplies electric power to each unit in the distance measuring device 1′ including the operation mode control unit 17.

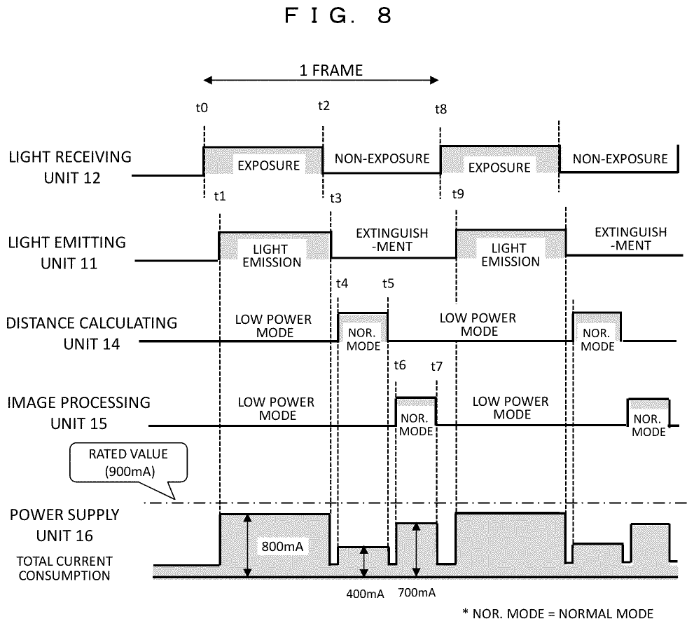

FIG. 8 is a time chart illustrating operations of each unit of the distance measuring device according to the second embodiment. The difference from the operation of the first embodiment (FIG. 5) is that, as the operation mode of the distance calculating unit 14, a “normal mode” in which normal distance calculating is performed and a “low power mode” in which the distance calculating is stopped are provided. Then, in the non-exposure period of the light receiving unit 12 (the extinguishment period of the light emitting unit 11), a period when the distance calculating unit 14 is set to the “normal mode” and a period when the image processing unit 15 is set to the “normal mode” are provided, and two periods are set not to overlap. Specifically, switching is performed so that the image processing is started after the distance calculating processing is completed. On the other hand, during the exposure period (light emission period of the light emitting unit 11) of the light receiving unit 12, both the distance calculating unit 14 and the image processing unit 15 are switched to the “low power mode”.

When the operation mode of the distance calculating unit 14 is switched to the low power mode, the clock frequency of the FPGA constituting the distance calculating unit 14 is stopped. By stopping the clock, the distance calculating unit 14 shifts to the standby mode, and the power consumption is significantly reduced.

In addition, the switching timings (t0, t1, . . . ) of operations of the respective units are set as follows. [1] Completion of exposure of the light receiving unit 12 (t2)->Stop of light emission of the light emitting unit 11 (t3)->Switching of the distance calculating unit 14 to the “normal mode” (t4)->After continuing for a predetermined time, switching of the distance calculating unit 14 to “low power mode” (t5)

[2] Switching of the image processing unit 15 to the “normal mode” (t6)->After continuing for a predetermined time, switching of the image processing unit 15 to the “low power mode” (t7)->Starting of exposure of the light receiving unit 12 (t8)->Starting of light emission of the light emitting unit 11 (t9)

In this order, the operations are performed, and a slight delay time (several msec) is provided for operations switching of each unit.

By setting the operation modes of both the distance calculating unit 14 and the image processing unit 15 to the low power mode as described above, all of the light emission period (t1 to t3) of the light emitting unit 11, the normal mode period (t4 to t5) of the distance calculating unit 14, and the normal mode period (t7 to t8) of the image processing unit 15 do not overlap. As a result, the peak value of the total current consumption of the power supply unit 16 is reduced to, for example, 800 mA during the light emission period (t1 to t3), 400 mA during the distance calculating period (t4 to t5), and 700 mA during the image processing period (t6 to t7), and these peak values can be suppressed to be less than the rated value of 900 mA. In addition, since the delay time is provided for the operation switching of each unit, the current consumption does not momentarily exceed the rated value due to the overlapping of the operations of the respective units during the operation switching.

According to the above-described operation mode, as compared with the first embodiment (FIG. 5), both the normal mode period (t4 to t5) of the distance calculating unit 14 and the normal mode period (t6 to t7) of the image processing unit 15 are shortened. Therefore, it is required to set the length of the non-exposure period (t2 to t8) so that the distance calculating of the light reception data obtained in the immediately previous exposure period (t0 to t2) and the image processing are completed. For this reason, it is preferable to determine that the distance calculating processing and the image processing have been completed and to switch to the next operation mode.

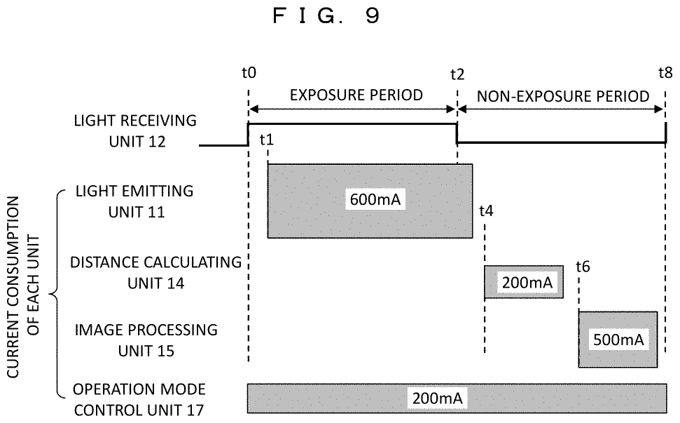

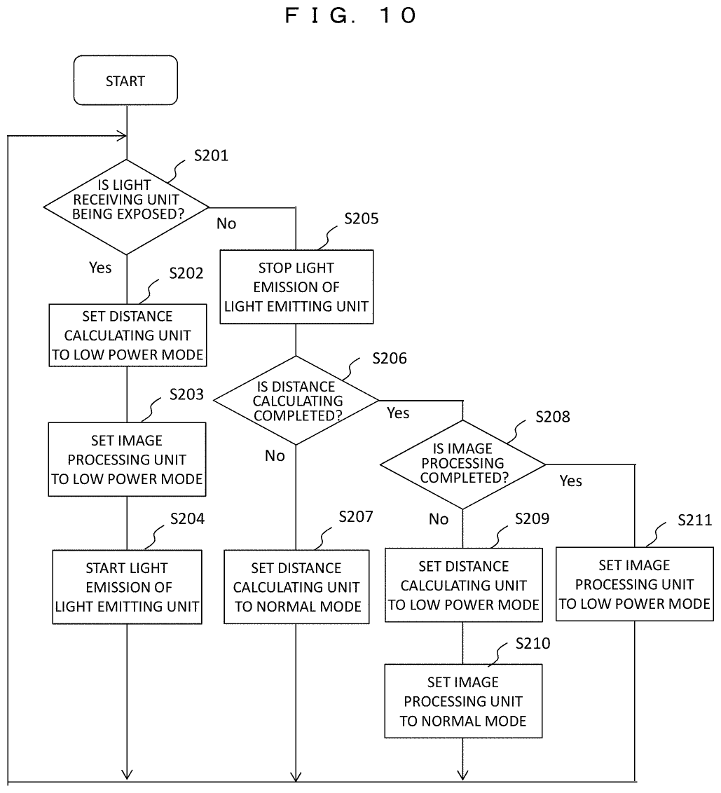

FIG. 9 is a diagram illustrating comparison of magnitudes of current consumption of respective units in FIG. 8. During the exposure period of the light receiving unit 12, the current consumption of the light emitting unit 11 is 600 mA, which is the largest. In the non-exposure period, the distance calculating unit 14 is shifted to the operation period of 200 mA and the image processing unit 15 is shifted to the operation period of 500 mA. The operation mode control unit 17 is always used, but the current consumption is as low as 200 mA. When these current values are summed, the total current consumption of the power supply unit 16 illustrated in FIG. 8 is obtained. In addition, since the operation mode control unit 17 does not exist in the first embodiment (FIG. 1), the current consumption of the operation mode control unit is not included in FIG. 5.

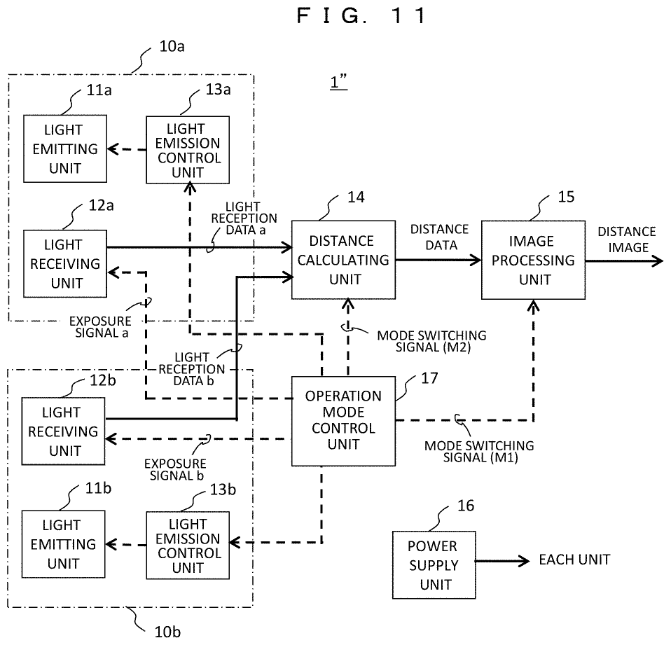

FIG. 10 is a flowchart for executing the operation switching of FIG. 8. The following processing is executed by the operation mode control unit 17 as a main component.

S201: The operation mode control unit 17 determines on the basis of the exposure signal from the light receiving unit 12 whether or not the light receiving unit 12 is being currently exposed. If it is being exposed (Yes), the process proceeds to S202; and if it is not being exposed (No), the process proceeds to S205.

S202: The operation mode of the distance calculating unit 14 is set to the low power mode. Specifically, the FPGA clock is stopped.

S203: The operation mode of the image processing unit 15 is set to the low power mode. Specifically, the clock frequency of the CPU is switched to, for example, several 100 kHz.

S204: The light emitting unit 11 is allowed to start the light emission (timing t1). After that, the process returns to S201.

S205: The light emitting unit 11 is allowed to stop the light emission (timing t3).

S206: The distance calculating unit 14 determines whether or not the distance calculating is completed. If the distance calculating is not completed (No), the process proceeds to S207; and if the distance calculating is completed (Yes), the process proceeds to S208.

S207: The operation mode of the distance calculating unit 14 is set to the normal mode (timing t4). Specifically, the clock of the FPGA is recovered. After that, the process returns to S201.

S208: The image processing unit 15 determines whether or not the image processing is completed. If the image processing is not completed (No), the process proceeds to S209; and if the image processing is completed (Yes), the process proceeds to S211.

S209: The operation mode of the distance calculating unit 14 is set to the low power mode (timing t5). Specifically, the FPGA clock is stopped.

S210: The operation mode of the image processing unit 15 is set to the normal mode (timing t6). Specifically, the clock frequency of the CPU is switched to, for example, 1 GHz. After that, the process returns to S201.

S211: The operation mode of the image processing unit 15 is set to the low power mode (timing t7). Specifically, the clock frequency of the CPU is switched to, for example, several 100 kHz. After that, the process returns to S201.

According to the second embodiment, in addition to the configuration of the first embodiment, since the operation mode is switched to the low power mode so that the light emission period of the light emitting unit 11, the distance calculating period of the distance calculating unit 14, and the image processing period of the image processing unit 15 do not overlap with each other, the total current consumption of the power supply unit 16 can be further reduced.

In addition, in the second embodiment, the case where the clock frequency of the CPU is reduced as a means for setting the image processing unit 15 to the low power mode has been described, but the present invention is not limited thereto. in the case where the image processing unit is embedded with a plurality of CPU cores, the frequency of the CPU cores in charge of the image processing may be reduced or stopped. In the case where the image processing unit 15 is configured with a plurality of CPU chips, the frequency of the CPU chips in charge of the image processing may be reduced or stopped.

### Third Embodiment

In a third embodiment, reduction of total current consumption in a distance measuring device having a plurality of TOF cameras will be described. Herein, the case where the method of the second embodiment is used to reduce the current consumption will be described, but it goes without saying that the case is also effective by applying the method of the first embodiment.

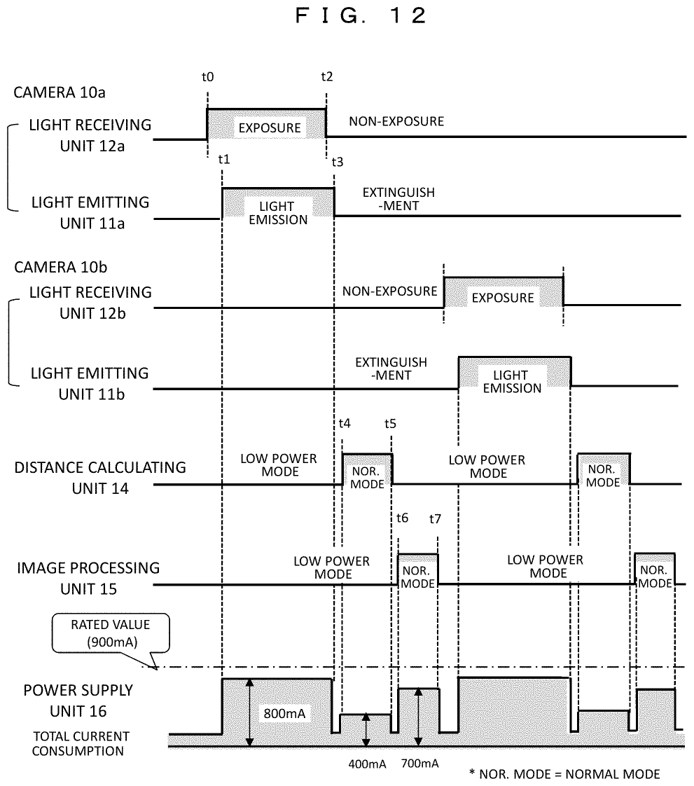

FIG. 11 is a diagram illustrating a configuration of the distance measuring device 1″ according to the third embodiment. In this example, the distance measuring device is configured to have two TOF cameras 10a and 10b and outputs a combination of the respective light reception data as a distance image. By using the plurality of TOF cameras 10a and 10b, for example, it is possible to measure the subject 2 from a plurality of directions, and it is possible to reduce the invisible portion that are behind the subject 2.

The light reception data from light receiving units 12a and 12b acquired by the TOF cameras 10a and 10b are input to the common distance calculating unit 14 to combine the distance data, and the image processing unit 15 outputs the combined distance image. The operation mode control unit 17 suppresses an increase in current consumption during the light emission by allowing light emitting units 11a and 11b to alternately emit light and allowing the light receiving units 12a and 12b to be alternately exposed. In addition, the operation mode control unit 17 transmits mode switching signals (M1 and M2) to the distance calculating unit 14 and the image processing unit 15, respectively and switches each operation mode between the normal mode and the low power mode. The mode switching at that time is performed similarly to the second embodiment.

FIG. 12 is a time chart illustrating operations of each unit of the distance measuring device according to the third embodiment. The two TOF cameras 10a and 10b alternately perform the exposure/light emission operation. Then, during the period when both TOF cameras 10a and 10b are not exposed, the normal mode period (t4 to t5) of the distance calculating unit 14 and the normal mode period (t7 to t8) of the image processing unit 15 are set not to overlap with each other. The switching timings (t0, t1, . . . ) of operations of the respective units are the same as those described in the second embodiment (FIG. 8), and a slight delay time (several msec) is provided for the operation switching of each unit.

As a result, the peak value of the total current consumption of the power supply unit 16 is similar to that of the second embodiment (FIG. 8) and is reduced to, for example, 800 mA during the light emission period (t1 to t3), 400 mA during the distance calculating period (t4 to t5), and 700 mV during the image processing period (t6 to t7), and these peak values can be suppressed to be less than the rated value of 900 mA.

In the above-described example, the case where the two TOF cameras 10a and 10b are provided has been described, but the configuration having three or more TOF cameras can be similarly employed.

According to the third embodiment, similarly to the second embodiment, in the distance measuring device including a plurality of TOF cameras, since the operation modes of the distance calculating unit 14 and the image processing unit 15 are switched to the low power mode, the total current consumption of the power supply unit 16 can be reduced. Needless to say, similarly to the first embodiment, the processing of the image processing unit 15 may be stopped during the light emission period.

The present invention is not limited to the above-described embodiments, but the present invention includes various modifications. For example, the distance calculating unit 14 and the image processing unit 15 are configured with an FPGA and a CPU, but other integrated circuits may be used as appropriate according to the required performance. In addition, the values of current consumption and the standard values described in the respective embodiments are examples, and it goes without saying that the values are appropriately set according to the system.

What is claimed is:

1. A distance measuring device measuring a distance to a subject by a time of flight of light, comprising:
a light emitting unit irradiating the subject with pulsed light emitted from a light source;
a light receiving unit exposing an image sensor to the pulsed light reflected by the subject and converting the pulsed light into an electrical signal;
a distance calculating unit calculating the distance to the subject from an output signal of the light receiving unit; and
an image processing unit generating a distance image of the subject from the distance calculated by the distance calculating unit,
wherein the image processing unit executes image processing within a period when the light emitting unit stops light emission and stops the image processing during a period when the light emitting unit emits light.

2. The distance measuring device according to claim 1,
wherein, when the light receiving unit starts exposure, the image processing of the image processing unit is stopped after a predetermined delay time, and the light emission of the light emitting unit is started after a predetermined delay time, and
wherein, when the light receiving unit completes exposure, the light emission of the light emitting unit is stopped after a predetermined delay time, and the image processing of the image processing unit is started after a predetermined delay time.

3. The distance measuring device according to claim 1, wherein, when the image processing unit stops the image processing, a clock frequency of an integrated circuit constituting the image processing unit is further reduced as compared with an image processing time.

4. A distance measuring device measuring a distance to a subject by a time of flight of light, comprising:
a light emitting unit irradiating the subject with pulsed light emitted from a light source;
a light receiving unit exposing an image sensor to the pulsed light reflected by the subject and converting the pulsed light into an electrical signal;
a distance calculating unit calculating the distance to the subject from an output signal of the light receiving unit;
an image processing unit generating a distance image of the subject from the distance calculated by the distance calculating unit; and
an operation mode control unit switching operation modes of the distance calculating unit and the image processing unit,
wherein, during a period when the light emitting unit performs light emission, the operation mode control unit sets the distance calculating unit to a low power mode in which calculation processing is stopped and sets the image processing unit to the low power mode in which image processing is stopped, and
wherein, within the period when the light emitting unit stops the light emission, the operation mode control unit sets a period of a normal mode in which the distance calculating unit executes the calculation process and a period of the normal mode in which the image processing unit executes the image processing not to overlap with each other.

5. The distance measuring device according to claim 4,
wherein, in order to switch the distance calculating unit to a low power mode, a clock signal of an integrated circuit constituting the distance calculating unit is stopped, and
wherein, in order to switch the image processing unit to the low power mode, a clock frequency of an integrated circuit constituting the image processing unit is further reduced as compared with a normal operation time.

6. The distance measuring device according to claim 4,
wherein, when the light receiving unit completes exposure, the operation mode control unit stops the light emission of the light emitting unit after a predetermined delay time and shifts the operation mode of the distance calculating unit to the normal mode after a predetermined delay time, and
wherein, when the operation mode of the image processing unit is switched to the low power mode, the light receiving unit starts the exposure after a predetermined delay time, and the light emitting unit starts the light emission after a predetermined delay time.

7. The distance measuring device according to claim 4, wherein the operation mode control unit sets the period of the normal mode of the distance calculating unit and the period of the normal mode of the image processing unit by determining that each process is completed and switching to the low power mode.

8. The distance measuring device according to claim 1, having a plurality of sets of the light emitting unit and the light receiving unit, each set performing the light emission/exposure in order,
wherein the distance calculating unit combines the output signals from the respective sets, and the image processing unit generates a combined distance image.
